(19) United States
(12) Patent Application Publication
(10) Pub. No.: US 2025/0161911 A1
(43) Pub. Date: May 22, 2025

(54) POLYMERS FOR THE REMOVAL OF PFAS FROM AQUEOUS COMPOSITIONS, AND METHODS OF MAKING AND USING THE SAME

(71) Applicant: Lutum Technology, LLC, Hanover, NH (US)

(72) Inventors: Alan Letton, Huntington, WV (US); Joseph J. BelBruno, Hanover, NH (US); Andrei Burnin, West Lebanon, NH (US)

(21) Appl. No.: 18/948,846

(22) Filed: Nov. 15, 2024

Related U.S. Application Data
(60) Provisional application No. 63/600,214, filed on Nov. 17, 2023.

(51) Int. Cl. B01J 20/26; B01J 20/28; B01J 20/34; C02F 1/28; C02F 101/36; C08J 3/24

(52) U.S. Cl. CPC B01J 20/267; B01J 20/268; B01J 20/28007; B01J 20/3425; B01J 20/3475; C02F 1/285; C08J 3/24; C02F 2101/36; C02F 2303/16

(57) ABSTRACT

Crosslinked molecularly imprinted polymers (MIPS) and methods for the same are provided. The crosslinked MIP may include a crosslinked polymer molecularly imprinted to have specific affinity for binding with a target substance. The target substance may include one or more perfluoroalkyl or polyfluoroalkyl substances (PFAS). The crosslinked polymer may be molecularly imprinted with the target substance, an analog of the target substance, or a combination thereof. Methods for utilizing the crosslinked MIP may include contacting the crosslinked MIP with an aqueous composition including the target substance, and adsorbing at least a portion of the target substance of the aqueous composition with the crosslinked molecularly imprinted polymer.

### CROSS-REFERENCE TO RELATED APPLICATIONS

This application claims priority to U.S. Provisional Patent Application No. 63/600,214 filed on Nov. 17, 2023, the contents of which are incorporated herein by reference to the extent consistent with the present disclosure.

### FIELD OF THE INVENTION

The present disclosure relates to processes to prepare cross-linked polymers suitable for use in the removal of polyfluorinated and perfluorinated substances (PFAS) from aqueous compositions or solutions.

### BACKGROUND OF THE INVENTION

Perfluoroalkyl and polyfluoroalkyl substances or perfluorinated and polyfluorinated substances (PFAS) are ubiquitous in the environment. PFAS possess relatively high chemical stability and/or resistance to degradation under ambient or normal temperature and pressure conditions. As such, energy-intensive, active methods are often utilized to facilitate the removal of PFAS from the environment. While activated carbon may often be utilized to sequester unwanted substances from the environment, a recent study found that activated carbon filters removed only about 73% of PFAS contaminants from aqueous compositions or solutions. Environ. Sci. Technol. Lett. 2020, 7, 3, 178-184.

What is needed, then, are improved materials and methods for removing PFAS from aqueous compositions.

### BRIEF SUMMARY OF THE INVENTION

The following presents a simplified summary of the claimed subject matter in order to provide a basic understanding of some aspects of the claimed subject matter. This summary is not an extensive overview of the claimed subject matter. It is intended to neither identify critical elements of the claimed subject matter nor delineate the scope of the claimed subject matter. Its sole purpose is to present some concepts of the claimed subject matter in a simplified form as a prelude to the more detailed description that is presented later.

The foregoing and/or other aspects and utilities described herein may be achieved by providing a crosslinked molecularly imprinted polymer (MIP). The crosslinked MIP may include a crosslinked polymer molecularly imprinted to have specific affinity for binding with a target substance. The target substance may include one or more perfluoroalkyl or polyfluoroalkyl substances (PFAS). The crosslinked polymer may be molecularly imprinted with the target substance, an analog of the target substance, or a combination thereof.

In one aspect, the crosslinked polymer may be one or more of a crosslinked polydiacetylene, a crosslinked polyvinylpyrrolidone, a crosslinked vinyl pyrrolidone-based polymer, a crosslinked poly(hydroxyethylmethacrylate), a crosslinked polyvinylidene chloride, a crosslinked polyaniline, a crosslinked poly(4-vinylphenol), a crosslinked polyurethane, a crosslinked nylon, a crosslinked polyvinylpyrrolidinone, a crosslinked polyethyleneimine, a crosslinked polystyrene, a crosslinked polymethylmethacrylate, or any combination thereof.

In one aspect, the crosslinked polymer may define a cavity capable of or configured to include specific affinity for binding with the target substance.

In one aspect, the cavity may be configured to bind with the target substance via non- covalent bonding.

In one aspect, the crosslinked polymer may be prepared by polymerizing monomers in the presence of a crosslinker.

In another aspect, the crosslinked polymer may be prepared by dissolving one or more polymers in a solvent, templating the polymers with the target substance, the analog of the target substance, or a combination thereof, and crosslinking the polymer after templating the polymers.

In one aspect, the molar ratio of the crosslinker to the monomers may be from about 1.5:1 to about 6:1.

In one aspect, the MIP may be in the form of particles including an average particle size of from about 100 nm to about 5 μm.

In one aspect, the MIP may be in the form of particles including an average particle size of from about 100 nm to about 500 nm.

In one aspect, the crosslinked polymer may be molecularly imprinted with one or more of perfluorooctanoic acid, perfluorooctanesulfonic acid, or a combination thereof.

In one aspect, the one or more PFAS may include one or more of Ethyl perfluorobutyl ether, Perfluorooctanesulfonic acid, Octafluoroadipamide, 2-Amino-2H-perfluoropropane, 1H,1H,5H-Perfluoropentanol, 3-(Perfluoro-2-butyl)propane-1,2-diol, Perfluoro(4-methoxybutanoic acid), Perfluoropentanamide, 11:1 Fluorotelomer alcohol, 2-(Perfluorooctyl)ethanol, Methyl perfluorobutanoate, Flurothyl, 4H-Perfluorobutanoic acid, Potassium perfluorobutanesulfonate, 4:4 Fluorotelomer alcohol, 3,3-Bis(trifluoromethyl)-2-propenoic acid, Perfluoropropyl trifluorovinyl ether, Perfluorobutanesulfonic acid, 3H-Perfluoro-4-hydroxy-3-penten-2-one, Heptafluorobutyramide, Perfluorobutanesulfonyl fluoride, 1H,1H-Perfluoropentylamine, 2-(Perfluorobutyl)-1-ethanesulfonic acid, N-Ethyl-N-(2-hydroxyethyl)perfluorooctane sulfonamide, 6H-Perfluorohex-1-ene, 1-Pentafluoroethylethanol, 1,1,1,3,3-Pentafluorobutane, Difluoromethyl 1H,1H-perfluoropropyl ether, Perfluorooctanoic acid, 2H,2H,3H,3H-Perfluorooctanoic acid, 3H-Perfluoro-2,2,4,4-tetrahydroxypentane, Perfluoro-3,6,9-trioxatridecanoic acid, 2-Aminohexafluoropropan-2-ol, 2-Vinylperfluorobutane, N-[(Perfluorooctylsulfonamido)propyl]-N,N,N-trimethylammonium iodide, Perfluoro-3,6-dioxaoctane-1,8-dioic acid, 3-(Perfluoropropyl)propanol, Perfluorohexanoic acid, Perfluoroisobutyl methyl ether, Pentafluoropropanoic anhydride, Methyl 2H,2H,3H,3H-perfluoroheptanoate, tris(Trifluoroethoxy)methane, 2,2-Difluoroethyl triflate, Perfluoroglutaryl difluoride, Hexafluoroamylene glycol, 3:1 Fluorotelomer alcohol, Nonafluoropentanamide, N-Methylperfluorooctanesulfonamide, 2-(Trifluoromethoxy)ethyl trifluoromethanesulfonate, Potassium perfluorogexabesulfonate, Bis(1H,1H-perfluoropropyl)amine, 3,3,4,4,5,5,6,6,6-Nonafluorohexene, 5H-Perfluoropentanal, Perfluoro-3,6-dioxaheptanoic acid, Sevoflurane, 1H,1H,8H,8H-Perfluoro-3,6-dioxaoctane-1,8-diol, N-Ethylperfluorooctanesulfonamide, Perfluorononanoic acid, Perfluorobutyraldehyde, Methyl perfluoroethyl ketone, Perfluorooctanesulfonamide, 3-(Perfluoroisopropyl)-2-propenoic acid, 4:2 Fluorotelomer alcohol, Methyl perfluorohexanoate, Allyl perfluoroisopropyl ether, 2-(Perfluorohexyl)ethanol, 2-(Perfluorohexyl)ethyl methacrylate, 5H-Octafluoropentanoyl fluoride, Perfluorobutanoic acid, 1H,1H,7H-Dodecafluoro-1-heptanol, Perfluoro-2-methyl-3-oxahexanoic acid, or any combination thereof.

In one aspect, about 1 g of the crosslinked molecularly imprinted polymer may be configured to remove greater than or equal to 80% of the target substance from about 100 ml of an aqueous composition.

In one aspect, the aqueous composition may be ground water, wastewater, tap water, a beverage, or a combination thereof.

The foregoing and/or other aspects and utilities described herein may be achieved by providing a filter including a vessel and the crosslinked molecularly imprinted polymer disclosed herein. The crosslinked molecularly imprinted polymer may be disposed in the vessel.

In one aspect, the vessel may include a body, an inlet, and an outlet. The body may define a volume disposed therein. The molecularly imprinted polymer may be disposed in the volume. The inlet may be fluidly coupled with the volume of the body. The outlet may be fluidly coupled with the inlet via the volume of the body.

The foregoing and/or other aspects and utilities described herein may be achieved by providing a method including contacting the crosslinked molecularly imprinted polymer disclosed herein with an aqueous composition including the target substance. The method may also include adsorbing a least a portion of the target substance of the aqueous composition with the crosslinked molecularly imprinted polymer.

In one aspect, the crosslinked molecularly imprinted polymer may define a cavity configured to include specific affinity for binding with the target substance. Adsorbing at least a portion of the target substance may include adsorbing the target substance into the cavity of the crosslinked molecularly imprinted polymer.

In one aspect, the method may include desorbing at least a portion of the target substance from the crosslinked molecularly imprinted polymer.

In one aspect, desorbing at least a portion of the target substance from the crosslinked molecularly imprinted polymer may include washing the crosslinked molecularly imprinted polymer with a solvent.

The foregoing and/or other aspects and utilities described herein may be achieved by providing a process for preparing a molecularly imprinted polymer (MIP) for extraction of at least one PFAS target molecule component from an aqueous composition. The process may include forming a first solution comprising a solvent, at least one of a PFAS target molecule, PFAS target molecule analog, or a combination thereof, and a monomer selected from N-vinylpyrrolidone, hydroxyethylmethacrylate, and combinations thereof. The process may also include adding a cross linker selected from: ethylene dimethacrylate, divinylbenzene, N,N′-methylene bisacrylamide, 1,4-butanediol dimethacrylate, or a combination thereof to the first solution to form a second solution. The process may further include adding a polymerization initiator to the second solution to form a third solution comprising the MIP, wherein the MIP may be associated with at least some of the PFAS target molecule or PFAS target molecule analog. The process may also include disassociating or adsorbing the PFAS target molecule or PFAS target molecule analog from the MIP.

In one aspect, the solvent may be methanol.

In one aspect, the molar ratio of the crosslinker to the monomer may be about 1.5:1 to about 4:1.

In one aspect, the polymerization initiator may include a dialkyldiazine.

In one aspect, the process may further include comprising isolating the MIP from the third solution.

In one aspect, the process may further include at least one of stirring the first solution, stirring the second solution, and stirring the first and second solutions.

In one aspect, the process may include stirring the second solution for at least 1 hour, at least 2 hours, at least 3 hours, at least 4 hours, at least 5 hours, at least 10 hours, at least 11 hours, at least 12 hours, or at least 13 hours prior to the addition a polymerization initiator.

In one aspect, the process may include stirring the second solution for 12-18 hours prior to addition a polymerization initiator.

In one aspect, the PFAS target molecule may be selected from those disclosed herein.

The foregoing and/or other aspects and utilities described herein may be achieved by providing a polymer prepared by the foregoing process.

The foregoing and/or other aspects and utilities described herein may be achieved by providing a method for extracting a PFAS target molecule from an aqueous composition. The method may include providing a solid phase extraction column including a molecularly imprinted polymer prepared by any of the foregoing processes. The method may also include flowing an aqueous composition including a target molecule through the solid phase extraction column. The method may further include collecting a purified aqueous composition from the solid phase extraction column. The purified aqueous composition may include at least 90 mol-% less of the PFAS target molecule compared to the aqueous solution.

The foregoing and/or other aspects and utilities described herein may be achieved by providing a method for extracting a PFAS target molecule from an aqueous composition. The method may include: providing a solid phase extraction column including a polyvinyl polypyrrolidone (PVPP) polymer; flowing an aqueous composition including a target molecule through the solid phase extraction column; and collecting a purified aqueous composition from the solid phase extraction column, wherein the purified aqueous composition may include at least 90 mol-% less of the PFAS target molecule compared to the aqueous solution.

The foregoing and/or other aspects and utilities described herein may be achieved by providing a process for preparing a molecularly imprinted polymer (MIP) for extraction of at least one PFAS target molecule component from an aqueous solution. The process may include: forming a first solution including a solvent, at least one of a PFAS target molecule, PFAS target molecule analog, or a combination thereof, and a monomer selected from N-vinylpyrrolidone, hydroxyethylmethacrylate, or combinations thereof; stirring the first solution; adding a cross linker to the stirred first solution to form a second solution; stirring the second solution for about 12 to about 18 hours; adding a polymerization initiator to the stirred second solution to form a third solution; heating the third solution and forming the MIP, wherein the MIP may be associated with at least some of the PFAS target molecule or PFAS target molecule analog; recovering the MIP from the heated third solution; and washing the polymer with the solvent to remove unreacted material from the polymer.

In one aspect, the solvent may include methanol.

In one aspect, the cross linker may be selected from: ethylene dimethacrylate, divinylbenzene, N,N′-methylene bisacrylamide, 1,4-butanediol dimethacrylate, and a combination thereof.

In one aspect, the polymerization initiator may include azobisisobutyronitrile.

The foregoing and/or other aspects and utilities described herein may be achieved by providing a method of extracting a PFAS target molecule from an aqueous composition using the polymer prepared by any one of the foregoing processes. The method may include flowing the aqueous composition including a PFAS target molecule through a solid phase extraction column including the polymer prepared by any of the foregoing processes; and collecting a purified aqueous composition with the solid phase extraction column, wherein the purified aqueous composition comprises at least 90 mol-% less of the PFAS target molecule compared to the aqueous composition.

In one aspect, the solvent may include a mixture of ethanol and water.

In one aspect, the method may include drying the washed polymer.

In one aspect, the purified aqueous composition may include at least 95 mol-% less of the PFAS target molecule compared to the aqueous composition.

In one aspect, the purified aqueous composition may include at least 99 mol-% less of the PFAS target molecule compared to the aqueous composition.

In one aspect, the purified aqueous composition may include at least 99.9 mol-% less of the PFAS target molecule compared to the aqueous composition.

In one aspect, the purified aqueous composition may include at least 99.99 mol-% less of the PFAS target molecule compared to the aqueous composition.

### DETAILED DESCRIPTION

This description and the accompanying drawings illustrate exemplary embodiments and should not be taken as limiting, with the claims defining the scope of the present description, including equivalents. Various mechanical, compositional, structural, and operational changes may be made without departing from the scope of this description and the claims, including equivalents. In some instances, well-known structures and techniques have not been shown or described in detail so as not to obscure the description. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, may include plural referents unless expressly and unequivocally limited to one referent. As used herein, the term “include” and its grammatical variants are intended to be non-limiting, such that recitation of items in a list is not to the exclusion of other like items that can be substituted or added to the listed items.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically disclosed all the possible subranges as well as individual numerical values within that range. As such, any value within the range may be selected as the terminus of the range. For example, description of a range such as from 1 to 5 should be considered to have specifically disclosed subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerals, numerical values, and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive), ±2% (inclusive), ±3% (inclusive), ±5% (inclusive), ±10% (inclusive), or ±15% (inclusive) of that numeral. It should further be appreciated that when a numerical range is discussed herein, any numerical value falling within the range is also specifically disclosed.

As used herein, “free” or “substantially free” of a material or substance may refer to a composition, component, or phase where the material is present in an amount of less than 10.0 wt %, less than 5.0 wt %, less than 3.0 wt %, less than 1.0 wt %, less than 0.1 wt %, less than 0.05 wt %, less than 0.01 wt %, less than 0.005 wt %, or less than 0.0001 wt % based on a total weight of the composition, component, or phase.

All references cited herein are hereby incorporated by reference in their entireties. In the event of a conflict in a definition with a cited reference, the present teachings control.

It is to be appreciated that certain features of the disclosed compositions and methods which are, for clarity, described herein in the context of separate embodiments, may also be provided in combination in a single embodiment. Conversely, various features of the disclosed compositions and methods that are, for brevity, described in the context of a single embodiment, may also be provided separately or in any sub-combination.

Various terms relating to aspects of the description are used throughout the specification and claims. Such terms are to be given their ordinary meaning in the art unless otherwise indicated. Other specifically defined terms are to be construed in a manner consistent with the definitions provided herein.

As used herein, “aqueous composition” may refer to a composition including at least water and PFAS or an aqueous composition that contains at least PFAS, and may also include other additional components. In some embodiments, the compositions may include PFAS dissolved and/or partially dissolved components in neutral or charged forms, or as a salt, hydrate, solvate, or complex. Illustrative examples of aqueous compositions may be or include, but are not limited to, groundwater, wastewater, tap water, treated water, process water or process fluids from industrial processes or plants, waste from industrial processes or plants, beverages, or the like, or any combination thereof. Illustrative beverages may be or include, but are not limited to, one or more of an alcoholic beverage, a non-alcoholic beverage, a dairy-based beverage, non-dairy based beverages, a low acid beverage (e.g., 4.6<pH<7), sodas, carbonated water, carbonated beverages, infused beverages (e.g., infused coffee), or the like, or any combination thereof. Illustrative dairy-based beverages may be or include, but are not limited to, animal milks, such as cow's milk, goat milk, or other milks derived from an animal. Illustrative non-dairy based beverages may be or include, but are not limited to plant-based milks, including those produced or derived from nuts, fruits, grains, legumes, or the like, such as soy milk, almond milk, hazelnut milk, coconut milk, cashew milk, rice milk, oat milk, hemp seed milk, or the like, or any combination thereof. As used herein, the expression “low acid beverage” may refer to any one or more beverages having a pH of greater than or equal to about 4.6 and less than 7. Illustrative low acid beverages may be or include, but are not limited to, coffee, cold-brew coffee, tea, ready-to-drink coffee, nitro cold-brew coffee, vegetable juice, fruit juice, dairy products, protein beverages (e.g., whey protein or plant-based protein beverages), or the like, or any combination thereof.

The present disclosure may refer to one or more polymers (e.g., MIPs), processes for preparing the polymers, and methods for removing or sequestering PFAS from aqueous compositions with the polymers. Where the disclosure describes or claims a feature or embodiment associated with a polymer, such a feature or embodiment may be equally applicable to the methods. Likewise, where the disclosure describes or claims a feature or embodiment associated with the methods, such a feature or embodiment may be equally applicable to the polymers.

The present disclosure is directed to methods or processes for preparing materials including polymers (e.g., crosslinked polymers, MIPs, etc.) having utility in the extraction, separation, removal, or otherwise sequestering of target substances from aqueous compositions and solutions. As further discussed herein, the target substances may be or include, but are not limited to, one or more perfluoroalkyl and polyfluoroalkyl substances (PFAS). The present disclosure is also directed to the materials including the polymers prepared by the methods disclosed herein. As further described herein, the materials or polymers thereof may be or include, but are not limited to, molecularly imprinted polymers (MIPs), articles of manufacture that may include or utilize the MIPs, such as separation columns and filters, or the like, or any combination thereof. The present disclosure may further be directed to methods for removing target substances from the aqueous compositions and solutions with the materials including the polymers.

As discussed above, the materials or the polymers thereof may be or include MIPs. Generally, MIPs are polymers, such as crosslinked polymers, that act as a host capable of or configured to interact with the target substance. MIPs may be materials designed to have specific binding sites that may be complementary to one or more properties or characteristics of the target substances. For example, the MIPs may have specific binding sites or cavities that may be complimentary to one or more of the following properties or characteristics of the target molecules (e.g., PFAS), including: shape, size, chemical functionality, charge (e.g., electrostatic, etc.), or the like, or any combination thereof. It should be appreciated that the MIPs may be selective for any one or more of these properties or characteristics of the target substances; and thus, may reject or exclude binding with other molecules or substances that may not be complimentary with the one or more properties or characteristics. For example, the MIP may interact with the target substance via non-covalent bonding, hydrogen bonding, electrostatic interactions, hydrophobic interactions, acid-base interactions, shape recognition, or the like, or any combination thereof. As further described herein, during the preparation of the MIPs, the MIPs may be interacting with or associated with the target substance such that the removal of the target substance creates a cavity in the MIP (e.g., an MIP cavity) that may be complementary to one or more properties or characteristics of the target substance. For example, the target substances may interact or be associated with the MIPs or the polymer thereof in such a way as to imprint and/or template the MIP or the polymer thereof upon removal of the target substances. It should be appreciated that the target substance may be reversibly associated, coupled, or otherwise bound to the MIP cavity. For example, the MIP cavity may absorb the target substance under certain conditions, and the target substance may be desorbed from the MIP cavity under other condition. The MIP host also may also have solvent compatibility with the target substance, and may be capable of forming a binding cavity around the target substance.

In at least one implementation, the MIPs may be crosslinked. Crosslinked MIPs may generally be prepared using solution chemistry in solvents (e.g., organic solvents) by combining, mixing, or otherwise contacting one or more of monomers, crosslinker(s), polymerization initiator(s), target substance(s) (e.g., target molecules, target homologs, target analogs, etc.), or any combination thereof, with one another. The MIP or host polymer may include a template or structural component (e.g., MIP cavity) for the target substance (e.g., target molecule and/or analog) that may be present during the formation of the MIP. For example, the MIP may be based on polyvinylpolypyrrolidone (PVPP), which is a shape/size recognition polymer, prepared by contacting monomers of the PVPP, a crosslinker (e.g., ethylene dimethacrylate), and an initiator (e.g., azobisisobutyronitrile) with one another. The target substances may be included during the preparation of the MIP such that polymerization and/or crosslinking results in the formation of the MIP cavity or the structural component. Any suitable initiator may be utilized and the initiator utilized may depend, at least in part, on any one or more of the crosslinker, the target substance(s), the monomers, or any combination thereof. For example, the initiator may be or include, but are not limited to, one or more free-radical initiators, ionic initiators, or the like, or any combination thereof. Illustrative initiators may be or include, but are not limited to, one or more of a halogen molecule, an azo compound, an organic peroxide, or the like, or any combination thereof.

Methods for preparing the polymers (e.g., MIPs) are disclosed herein. The method for preparing the polymers may generally include combining, mixing, dispersing, dissolving, or otherwise contacting monomers and a first solvent with one another to prepare a first solution. The method may also include contacting a crosslinker with the first solution to prepare a second solution. It should be appreciated that the order of contacting the monomers and the crosslinker with the first solvent is not limited. For example, the method may include contacting the first solvent with the crosslinker to prepare the first solution, and subsequently contacting the monomers with the first solution to prepare the second solution. In another example, the crosslinker and the monomers may be concurrently contacted with the first solvent. The method may also include agitating, stirring, or otherwise mixing the first solution, the second solution, or a combination thereof. The method may also include contacting the target substance with the first solution, the second solution, or a combination thereof. The method may further include contacting an initiator (e.g., polymerization initiator) with the second solution, and activating the initiator to prepare or form the polymers or solid polymers. The method may also include isolating the polymers. For example, the method may include recovering the solid polymers via filtration or other means known in the art. The method may also include washing the polymers with a suitable solvent. Washing the polymer may remove any unreacted monomers or reactant. In at least one implementation, the polymers may be in the form of particles, powders, films, sheets, layers, or the like. The polymers may be utilized in solid phase extraction (SPE) of the target molecules (e.g., PFAS) from the aqueous compositions or solutions.

In at least one implementation, the MIPs and/or the polymers thereof may be in the form of powders or particles. The powder or the particles thereof may have an average particle size of from about 100 nm to about 5 μm. For example, the powder of the particles thereof may have an average particle size of from about 100 nm, about 200 nm, about 300 nm, about 400 nm, about 500 nm, or about 600 nm to about 800 nm, about 900 nm, about 1 μm, about 2 μm, about 3 μm, about 4 μm, or about 5 μm.

In at least one implementation, the MIPs and/or the polymers thereof may have a pore size of from about 2 nm to about 100 nm. For example, the MIPs and/or the polymers thereof (e.g., powders, particles, etc.) may have a pore size of from about 2 nm, about 4 nm, about 10 nm, about 20 nm, about 30 nm, about 40 nm, or about 50 nm to about 60 nm, about 70 nm, about 80 nm, about 90 nm, or about 100 nm. In another example, the MIPs and/or the polymers thereof may have a pore size of from about 2 nm to about 100 nm, about 10 nm to about 90 nm, about 20 nm to about 80 nm, about 30 nm to about 70 nm, about 40 nm to about 60 nm, or about 50 nm. In another example, the MIPs and/or the polymers thereof may have a pore size of from greater than or equal to about 1 nm, greater than or equal to about 5 nm, greater than or equal to about 10 nm, greater than or equal to about 20 nm, greater than or equal to about 30 nm, greater than or equal to about 40 nm, greater than or equal to about 50 nm, greater than or equal to about 60 nm, greater than or equal to about 70 nm, greater than or equal to about 80 nm, greater than or equal to about 90 nm, and/or up to 100 nm or greater. In yet another example, the MIPs and/or the polymers thereof may have a pore size of from greater than or equal to 1 nm to less than or equal to about 5 nm, less than or equal to about 10 nm, less than or equal to about 20 nm, less than or equal to about 30 nm, less than or equal to about 40 nm, less than or equal to about 50 nm, less than or equal to about 60 nm, less than or equal to about 70 nm, less than or equal to about 80 nm, less than or equal to about 90 nm, or less than or equal to about 100 nm.

In at least one implementation, the MIPs and/or the polymers thereof may have a surface area, such as a Brunauer, Emmett, and Teller (BET) surface area of from about 10 square meters per gram (m²/g) to about 200 m²/g or more. For example, the MIPs and/or the polymers thereof may have a surface area of about 10 m²/g, about 20 m²/g, about 30 m²/g, about 40 m²/g, about 50 m²/g, about 60 m²/g, about 70 m²/g, about 80 m²/g, about 90 m²/g, about 100 m²/g, about 110 m²/g, about 120 m²/g, about 130 m²/g, about 140 m²/g, about 150 m²/g, about 160 m²/g, about 170 m²/g, 180 m²/g, about 190 m²/g, or about 200 m²/g. In another example, the MIPs and/or the polymers thereof may have a surface area of from about 10 m²/g to about 200 m²/g, about 20 m²/g to about 180 m²/g, about 40 m²/g to about 160 m²/g, about 60 m²/g to about 140 m²/g, about 80 m²/g to about 120 m²/g, or about 100 m²/g. In another example, the MIPs and/or the polymers thereof may have a surface area of from greater than or equal to about 10 m²/g, greater than or equal to about 20 m²/g, greater than or equal to about 30 m²/g, greater than or equal to about 40 m²/g, greater than or equal to about 60 m²/g, greater than or equal to about 80 m²/g, greater than or equal to about 100 m²/g, greater than or equal to about 120 m²/g, greater than or equal to about 140 m²/g, greater than or equal to about 160 m²/g, greater than or equal to about 180 m²/g, to about 200 m²/g, or greater. In yet another example, the MIPs and/or the polymers thereof may have a surface area of from greater than or equal to 10 m²/g to less than or equal to about 200 m²/g, less than or equal to about 180 m²/g, less than or equal to about 160 m²/g, less than or equal to about 140 m²/g, less than or equal to about 120 m²/g, less than or equal to about 100 m²/g, less than or equal to about 80 m²/g, less than or equal to about 60 m²/g, less than or equal to about 40 m²/g, less than or equal to about 30 m²/g, or less than or equal to about 20 m²/g.

In at least one implementation, the second solution, which may include one or more of the monomers, the crosslinker, the solvent, or any combination thereof, may be agitated, stirred, or otherwise mixed for a predetermined period of time. For example, the second solution may be agitated for at least 1 hour, at least 2 hours, at least 3 hours, at least 4 hours, at least 5 hours, at least 10 hours, at least 11 hours, at least 12 hours, at least 13 hours, or more prior to addition of the initiator. In at least one implementation, the second solution may be agitated from about 12 to about 18 hours prior to addition of the initiator. The initiator may be or include, but is not limited to, one or more of a dialkyldiazene, such as azobisisobutyronitrile (AIBN), or the like, or any combination thereof. In at least one implementation, the initiator may be activated by heating to a temperature above room temperature, such as to from about 50° C. to about 70° C. In at least one implementation, the second solution including the initiator may be purged with an inert gas, such as nitrogen.

In at least one implementation, the MIPs or the polymers thereof may be or include, but are not limited to, one or more of a polydiacetylene (PDA), a polyvinylpolypyrrolidone (PVPP), a crosslinked vinyl pyrrolidone-based polymer, a poly(hydroxyethylmethacrylate) (pHEMA), vinylidene chloride-based polymers or polymers based on vinylidene chloride, polyaniline (PANi), poly(4-vinylphenol), polyurethane, nylon, poly(2-vinylpyrole), poly(4-vinylpyridine), polyvinylpyrrolidinone (PVPy), polyethyleneimine (PEI), nylon-6, polystyrene, polymethylmethacrylate (PMMA), copolymers thereof, blends thereof, or the like, or any combination thereof. In at least one implementation, the MIPs or the polymers thereof may be prepared by polymerizing monomers with the crosslinker and the initiator in the presence of the target substances. For example, the MIPs may be prepared by polymerizing the monomers in the presence of the target substances to thereby template the MIPs with the target substances. In another implementation, the MIPs may be prepared by dissolving one or more polymers in a solvent via the phase inversion synthesis.

The one or more solvents utilized to prepare the materials, the MIPs, or the polymers thereof may vary widely. The one or more solvents may be or include one or more organic solvents, one or more aqueous solvents, or a combination thereof. The one or more solvents utilized may depend, at least in part, on one or more components for preparing the MIPs, the conditions for preparing the MIPs, the target substances, properties (e.g., solubility) thereof, or the like, or any combination thereof. For example, the one or more solvents utilized to prepare the materials, the MIPs, or the polymers thereof may depend, at least in part, on the solubility of the polymers of the MIP in the solvent, the solubility of the target substances in the solvent, the polymers synthesized, the solubility of the crosslinker, the solubility of the monomers, or the like, or any combination thereof. Illustrative solvents may be or include, but are not limited to, one or more of alcohols (e.g., methanol, ethanol, propanol, butanol, etc.), dimethylformamide (DMF), water, formic acid, toluene, chloroform, or the like, or any combination thereof. In at least one implementation, at least one of the solvents may be capable of or configured to solubilize the monomers and the crosslinker. In at least one implementation, the one or more solvents may be or include a polar protic solvent. For example, the solvent may be an alcohol, such as methanol. In at least one example, the first solvent may be or include methanol. In another example, the one or more solvents may be or include a combination or mixture of water and an polar protic solvent. For example, the solvent utilized for removing the target substances from the MIPs or washing the MIPs may be or include a mixture of water and an alcohol, such as methanol, ethanol, or a combination thereof. It should be appreciated by one having ordinary skill in the art that the selection of the polymer and/or the solvent may allow for tuning or modifying the methods for preparing the MIPs to the chemistry of the target substances. For example, the solvents utilized for preparing the MIPs may be or include, but are not limited to, the following: ethanol for MIPs prepared from poly(4-vinylphenol) (P4VP) and/or poly(4-vinylphenol) poly(methylmethacrylate) (P4VP-PMMA); dimethylformamide for MIPs prepared from polyurethane (PU); methanol for MIPs prepared from poly(vinylpolypyrrolidone) (PVPP) and/or HEMA; and/or toluene for MIPs prepared from poly(methylmethacrylate) (PMMA).

The monomers utilized to prepare the MIPs or the polymers thereof may be or include any monomers suitable or capable of polymerizing to form any one or more of the polymers disclosed herein and copolymers thereof. For example, the monomers utilized to prepare the polymers (e.g., MIPs) disclosed herein may be or include, but are not limited to, one or more of N-vinylpyrrolidone, hydroxyethylmethacrylate (HEMA), urethane, 4-vinylphenol, methylmethacrylate, or the like, or any combination thereof.

The crosslinkers or crosslinking agents may include crosslinking monomers, crosslinking molecules, or the like, or any combination thereof. The crosslinkers may be capable of or configured to facilitate the crosslinking of the polymers. The crosslinkers may be a multifunctional molecule including a plurality of reactive groups. For example, the crosslinkers may include at least two or more polymerizable groups. Illustrative crosslinkers may be or include, but are not limited to, one or more of 2-(2-Methyl-acryloyloxy)ethyl 2-methyl-acrylate, ethylene dimethacrylate, divinylbenzene, methacrylic acid, ethylene ester, 1,2-bis(methacryloyloxy)ethane, 1,2-ethanediol dimethacrylate, diglycol dimethacrylate, ethanediol dimethacrylate, ethylene glycol bis(methacrylate), ethylene glycol dimethacrylate (EGDMA), ethylene methacrylate, diethylene glycol dimethacrylate (DEGDMA), triethylene glycol dimethacrylate (TEGDMA), N,N′-methylene bisacrylamide, 1,4-butanediol dimethacrylate, diacrylate, dimethacrylate, or the like, or any combination thereof.

In at least one implementation, the weight ratio of the crosslinker (e.g., EGDMA) to the monomer (e.g., NVP) may be from about 3:1 (i.e., about 3 to about 1) to about 10:1. For example, the weight ratio of the crosslinker to the monomer may be from about 3:1 to about 10:1, about 4:1 to about 9:1, about 5:1 to about 7.5:1, or about 6:1 to about 7:1. The molar ratio of the crosslinker to the monomer may be from about 1.5:1 to about 6:1. For example, the molar ratio of the crosslinker to the monomer may be from about 1.5:1 to about 6:1, about 1.5:1 to about 5:1, about 1.5:1 to about 4:1, about 1.5:1 to about 3:1, or about 1.5:1 to about 2:1.

In an exemplary implementation, the MIP or the polymer thereof may be prepared by the polymerization of monomers, namely, hydroxyethylmethacrylate, with a crosslinker or a crosslinking molecule, such as ethylene glycol dimethacrylate (EGDMA), divinylbenzene, N,N′-methylene bisacrylamide, 1,4-butanediol dimethacrylate, or the like, or any combination thereof.

In an exemplary implementation, the MIPs or the polymers thereof may be or include, but are not limited to, vinylidene chloride-based polymers or polymers based on vinylidene chloride. Methods for preparing the vinylidene chloride-based polymers may include contacting the vinylidene chloride-based polymers with a first solvent to prepare a first solution. The vinylidene chloride-based polymers may be dispersed, dissolved, mixed, or otherwise contacted with the first solvent to prepare the first solution. The method may also include contacting the target substance (e.g., target molecule and/or a target molecule analog) with the first solution to prepare a second solution. The method may further include mixing the second solution to prepare an MIP network solution. The method may also include recovering a composition including the MIP and the target substance from the MIP network solution. The composition including the MIP and the target substance may be recovered from the MIP network solution via any known method, such as precipitation with a solvent (e.g., second solvent) and filtration. The method may also include removing or separating the target substance from the composition. Removing or separating the target substance from the composition may include contacting the composition with a solvent (e.g., third solvent) capable of or configured to separate, remove, or otherwise desorb the target substance from the MIP.

The target substance, which may also be referred to as target materials or target analytes, may be in a liquid form, a solid form, a gaseous form, or any combination thereof. In an exemplary implementation, the target substance may be a liquid. For example, the target substance may be dissolved in a solution, such as an aqueous solution. In another example, the target substance may be a solid mixed, dispersed, or otherwise dissolved in the solution. As used herein, the expression “target substance(s)” or the like may refer to target molecules, target molecule homologs, target molecule analogs, target molecule isomers, target molecule stereoisomers, or the like, or any combination thereof. As used herein, an analog may refer to compounds with similar electronic structures but different atoms. Analogs may be or include isosteres and isologs. As used herein, the term “isosteres” may refer to one of a plurality of atoms or atomic groups having an analogous arrangement of electrons and similar physical properties. As used herein, the term “isolog” or “isologue” refers to a member of a series of compounds of similar structure, but having different atoms of the same valency and usually of the same periodic group. As used herein, the term “homolog” or “homologue” may refer to a member of a series of compounds whose structure differs regularly by some radical from that of its adjacent neighbor in the series.

In an exemplary implementation, the target substance may be or include, but is not limited to, one or more PFAS, PFAS analogs, or the like, or a combination thereof. The PFAS may be or include, but are not limited to, perfluroalkyl acids (PFAAs), fluorotelomer alcohols (FTOHs), fluorotelomer sulfonates (FTSs), perfluoroalkyl ether acids (PFEAs), polyfluoroalkyl phosphates (PAPs), perfluoropolyethers (PFPEs), perfluorododecanoic acid (PFDoA), perfluorohexane sulfonate (PFHxS), fluorinated sulfonamides, C6 fluorotelomers, short-chain PFAAs, or the like, or any combination thereof. The PFAs may also include any one or more of those listed at the U.S. Environmental Protection Agency (EPA), the details of which are available at [https://comptox.epa.gov/dashboard/chemical-lists/epapfas75s1] (last accessed on Oct. 23, 2024). Illustrative PFAS may be or include, but are not limited to, any one or more of 2-(Trifluoromethoxy)ethyl trifluoromethanesulfonate, 1H,1H,5H-Perfluoropentanol, Perfluoropropyl trifluorovinyl ether, Ethyl perfluorobutyl ether, Difluoromethyl 1H,1H-perfluoropropyl ether, Perfluorobutyraldehyde, N-Ethylperfluorooctane sulfonamide, Allyl perfluoroisopropyl ether, 6H-Perfluorohex-1-ene, 3-(Perfluoro-2-butyl)propane-1,2-diol, Fluorotelomer alcohol 4:2, N-Methylperfluorooctanesulfonamide, Methyl perfluorohexanoate, 5H-Perfluoropentanal, Perfluoro-3,6-dioxaoctane-1,8-dioic acid, Heptafluorobutyramide, Perfluorobutanesulfonyl fluoride, 2H,2H,3H,3H-Perfluorooctanoic acid, 3,3-Bis(trifluoromethyl)-2-propenoic acid, Perfluorohexanoic acid, Perfluorooctanesulfonic acid, Potassium perfluorobutanesulfonate, Potassium perfluorohexanesulfonate, 2,2-Difluoroethyl triflate, Perfluoro-3,6-dioxaheptanoic acid, Perfluorooctanesulfonamide, tris(Trifluoroethoxy)methane, 2-(Perfluorohexyl)ethyl methacrylate, Hexafluoroamylene glycol, 4:2 Fluorotelomer sulfonic acid, 3-(Perfluoroisopropyl)-2-propenoic acid, Methyl perfluorobutanoate, 3:1 Fluorotelomer alcohol, Perfluorobutanoic acid, Perfluoroglutaryl difluoride, Perfluorobutanesulfonic acid, Perfluoro-3,6,9-trioxatridecanoic acid, 2-Vinylperfluorobutane, Bis(1H,1H-perfluoropropyl)amine, Perfluoroisobutyl methyl ether, Methyl 2H,2H,3H,3H-perfluoroheptanoate, Fluorotelomer alcohol 6:2, Flurothyl, 1,1,1,3,3-Pentafluorobutane, 4H-Perfluorobutanoic acid, N-Ethyl-N-(2-hydroxyethyl)perfluorooctane sulfonamide, 4:4 Fluorotelomer alcohol, 1H,1H-Perfluoropentylamine, 3-(Perfluoropropyl)propanol, Nonafluoropentanamide, (Perfluorobutyl)ethene, Perfluoro(4-methoxybutanoic acid), Fluorotelomer alcohol 8:2, Perfluoropentanamide, 1-Propenylperfluoropropane, 3H-Perfluoro-2,2,4,4-tetrahydroxypentane, 5H-Octafluoropentanoyl fluoride, 1H,1H,8H,8H-Perfluoro-3,6-dioxaoctane-1,8-diol, 2-Amino-2H-perfluoropropane, Pentafluoropropanoic anhydride, 1-Pentafluoroethylethanol, Perfluoro-2-methyl-3-oxahexanoic acid, Octafluoroadipamide, Perfluorononanoic acid, Perfluorooctanoic acid, 11:1 Fluorotelomer alcohol, Potassium perfluorooctanesulfonate, Ammonium perfluorooctanoate, 2-Aminohexafluoropropan-2-ol, Sevoflurane, N- [(Perfluorooctylsulfonamido) propyl]-N,N,N-trimethylammonium iodide, 3H-Perfluoro-4-hydroxy-3-penten-2-one, Methyl perfluoroethyl ketone, 1H,1H,7H-Dodecafluoro-1-heptanol, Ethyl perfluorobutyl ether, Perfluorooctanesulfonic acid, Octafluoroadipamide, 2-Amino-2H-perfluoropropane, 1H,1H,5H-Perfluoropentanol, 3-(Perfluoro-2-butyl)propane-1,2-diol, Perfluoro(4-methoxybutanoic acid), Perfluoropentanamide, 11:1 Fluorotelomer alcohol, 2-(Perfluorooctyl)ethanol, Methyl perfluorobutanoate, Flurothyl, 4H-Perfluorobutanoic acid, Potassium perfluorobutanesulfonate, 4:4 Fluorotelomer alcohol, 3,3-Bis(trifluoromethyl)-2-propenoic acid, Perfluoropropyl trifluorovinyl ether, Perfluorobutanesulfonic acid, 3H-Perfluoro-4-hydroxy-3-penten-2-one, Heptafluorobutyramide, Perfluorobutanesulfonyl fluoride, 1H,1H-Perfluoropentylamine, 2-(Perfluorobutyl)-1-ethanesulfonic acid, N-Ethyl-N-(2-hydroxyethyl)perfluorooctane sulfonamide, 6H-Perfluorohex-1-ene, 1-Pentafluoroethylethanol, 1,1,1,3,3-Pentafluorobutane, Difluoromethyl 1H,1H-perfluoropropyl ether, Perfluorooctanoic acid, 2H,2H,3H,3H-Perfluorooctanoic acid, 3H-Perfluoro-2,2,4,4-tetrahydroxypentane, Perfluoro-3,6,9-trioxatridecanoic acid, 2-Aminohexafluoropropan-2-ol, 2-Vinylperfluorobutane, N-[(Perfluorooctylsulfonamido)propyl]-N,N,N-trimethylammonium iodide, Perfluoro-3,6-dioxaoctane-1,8-dioic acid, 3-(Perfluoropropyl)propanol, Perfluorohexanoic acid, Perfluoroisobutyl methyl ether, Pentafluoropropanoic anhydride, Methyl 2H,2H,3H,3H-perfluoroheptanoate, tris(Trifluoroethoxy)methane, 2,2-Difluoroethyl triflate, Perfluoroglutaryl difluoride, Hexafluoroamylene glycol, 3:1 Fluorotelomer alcohol, Nonafluoropentanamide, N-Methylperfluorooctanesulfonamide, 2-(Trifluoromethoxy)ethyl trifluoromethanesulfonate, Potassium perfluorooctanesulfonate, Ammonium perfluorooctanoate, 1-Propenylperfluoropropane, Potassium perfluorohexanesulfonate, Bis(1H,1H-perfluoropropyl)amine, 3,3,4,4,5,5,6,6,6-Nonafluorohexene, 5H-Perfluoropentanal, Perfluoro-3,6-dioxaheptanoic acid, Sevoflurane, 1H,1H,8H,8H-Perfluoro-3,6-dioxaoctane-1,8-diol, N-Ethylperfluorooctanesulfonamide, Perfluorononanoic acid, Perfluorobutyraldehyde, Methyl perfluoroethyl ketone, Perfluorooctanesulfonamide, 3-(Perfluoroisopropyl)-2-propenoic acid, 4:2 Fluorotelomer alcohol, Methyl perfluorohexanoate, Allyl perfluoroisopropyl ether, 2-(Perfluorohexyl)ethanol, 2-(Perfluorohexyl)ethyl methacrylate, 5H-Octafluoropentanoyl fluoride, Perfluorobutanoic acid, 1H,1H,7H-Dodecafluoro-1-heptanol, Perfluoro-2-methyl-3-oxahexanoic acid, octyl-sulfonic acid, octyl-acetic acid, or the like, or analogs thereof, or any combination thereof. The PFAS, PFAS analogs, or the like, may also be or include, but are not limited to, one or more PFAS including or modified (e.g., functionalized) to include one or more acidic head groups. The PFAS, PFAS analogs, or the like, may also be or include, but are not limited to, one or more PFAS including or modified (e.g., functionalized) to include one or more fluorinated alkyl chains having a carboxylic acid functional group, a sulfonic acid functional group, or a combination thereof. For example, the target molecule(s) may be or include PFAS, PFAS analogs, or the like, having fluorinated alkyl chains capped by a carboxylic acid functionality, a sulfonic acid functionality, or a combination thereof. In an exemplary implementation, the PFAS or PFAS analogs may be or include, but are not limited to, perfluorooctanoic acid, perfluorooctanesulfonic acid, or the like, or any combination thereof.

In at least one implementation, the method for preparing the MIPs or the polymers thereof may be or may be referred to as an “in situ method” or an “in situ production process.” As further described herein, the in situ production process may prepare polymers that are relatively more robust than polymers (e.g., MIPs) prepared from conventional methods. The in situ production process may also form polymers that may be rechargeable. For example, the polymers may be capable of or configured to absorb the target molecules from the aqueous compositions, and subsequently the target molecules may be desorbed from the polymers to regenerate or recharge the polymers.

In at least one implementation, the in situ method may include contacting a solvent, monomers, and one or more target substances with one another to prepare a first solution. The method may also include contacting a crosslinker to the first solution to prepare a second solution. The method may further include agitating the first solution, the second solution, or a combination thereof, for a predetermined period of time. For example, the method may include agitating (e.g., mixing or stirring) the second solution for a period of from about 12 hours to about 18 hours. The method may also include contacting the initiator (e.g., polymerization initiator) with the second solution to prepare a third solution. The method may also include activating the initiator to facilitate polymerization of the monomers to form the MIP with templating from the target substances. Activating the initiator may include heating the third solution or the initiator dispersed therein. The method may also include recovering the MIP from the third solution. The method may further include washing the MIP with a solvent to separate the target substance from the MIP.

In at least one implementation, the in situ method may include contacting the solvent, the monomers, and the target substances to prepare a first solution. The method may also include contacting the crosslinker with the first solution to prepare a second solution. The method may further include agitating the first solution, the second solution, or a combination thereof, for a predetermined period of time. For example, the method may include agitating (e.g., mixing or stirring) the first solution for a period of about 30 minutes or more, and agitating the second solution for a period of from about 12 hours to about 18 hours. The method may also include contacting an initiator to the second solution to prepare a third solution. The method may further include purging the third solution or a solution including the initiator, the solvent, the monomers, the target substances, and the crosslinker with an inert gas, such as nitrogen, for a predetermined period of time. For example, the method may include purging the third solution for at least 5 min or more, or at least 10 min or more. The method may further include heating the third solution. The third solution may be heated before or after purging. The third solution may be heated to a temperature of about 50° C., about 60° C., or more. The third solution may be heated for a period of about 2 hours or more, or about 3 hours or more. Heating the third solution may activate the initiator to facilitate polymerization of the monomers to prepare the polymerized, solid MIP. The method may include recovering or separating the polymerized, solid MIP. The method may also include washing the solid MIP with a solvent to remove at least a portion of the target substances. The method may further include drying the solid MIP. It should be appreciated that any one or more of the foregoing steps may be excluded. For example, the method may exclude purging the solution with the inert gas. It should be further be appreciated that any two or more of the foregoing steps may be combined with one another into a single step. For example, the solvent, the monomers, the target substances, and the crosslinker may be concurrently contacted with one another.

In at least one implementation a method for preparing a polymer for extracting at least one PFAS target molecule component disposed in an aqueous composition or solution may include any one or more of the following: mixing a solvent and monomers to form a first solution; stirring the first solution; adding a crosslinker to the first solution to form a second solution; stirring the second solution for about 12 to about 18 hours; adding a polymerization initiator to the second solution to form a third solution; heating the third solution to prepare the MIP, wherein the MIP is associated with at least some of the target substances, such as PFAS and/or analogs thereof; recovering the MIP from the third solution; and washing the MIP with a solvent to remove any unreacted material and/or the target substances from the MIP.

In at least one implementation, the in situ method may include any one or more of the following: first, add solvent and monomer to create a first solution and stir the first solution for about 30 minutes; second, add crosslinker to first solution to form a second solution and stir for about 12 to 18 h; third, add polymerization initiator to the second solution to form a third solution, purge with nitrogen for 10 min, seal and heat the third solution in an oven at 60° C. for about 3 h; fourth, recover solid polymer that forms, wash in solvent until any unreacted material is removed; fifth, air dry and store.

In at least one implementation, the method may include a phase inversion synthesis of the MIPs and/or the polymers thereof. The phase inversion synthesis may include contacting one or more polymers, the target substance(s) (e.g., PFAS), and a solvent with one another to develop a polymer-template network. In one example, the polymers, the target substances, and the solvent may be agitated for a predetermined period of time (e.g., >6 h, >12 h, or more) to facilitate the preparation or formation of the polymer-template network. The MIP may be prepared by precipitating the polymer-template network from the solution with a suitable solvent. The solvent used for dissolving the polymer may be or include, but is not limited to, a cycloketone, such as cyclohexanone, cycoheptanone, cyclooctenone, or any combination thereof. For copolymers of vinylidene chloride and (meth)acrylate, suitable solvents may be or include, but are not limited to, cycloketones, tetrahydrofuran (THF), dimethylformamide (DMF), ethylacetate, or any combination thereof. Solvents suitable for precipitating the polymer may include, but are not limited to, water, hexane, diethyl ether, or the like, or any combination thereof.

It should be appreciated that additional monomers, crosslinkers, solvents, process variables, process conditions, methods, or the like, may be described in, U.S. Patent Pub. No. 2010/0039124 A1, U.S. Patent Pub. No. 2014/0227795 A1, U.S. Patent Pub. No. 2014/0242237 A1, U.S. Patent Pub. No. 2014/0242601 A1, U.S. Patent Pub. No. 2015/0232598 A1, U.S. Patent Pub. No. 2015/0241374 A1, U.S. Patent Pub. No. 2016/0084788 A1, U.S. Patent Pub. No. 2018/0291129 A1, U.S. Patent Pub. No. 2018/0292341 A1, and U.S. Patent Pub. No. 2020/0225202 A1, the contents of which are herein incorporated by reference in the entirety to the extent consistent with the present disclosure.

Methods for separating or removing PFAS and/or PFAS analogs from an aqueous composition or aqueous solution are disclosed. The aqueous composition may be a liquid, a gel, a slurry, or the like. The method may include contacting the aqueous composition or the aqueous solution including PFAS with the materials including the MIPs and/or the polymers thereof. Contacting the aqueous composition or the aqueous solution with the MIPs and/or the polymers thereof may include physical contact therebetween. For example, contacting may include a liquid-solid phase interaction, a solid-gas interaction, or a combination thereof. The method may also include adsorbing the PFAS with the MIPs. The method may further include desorbing the PFAS from the MIPs. In at least one implementation, the PFAS dissolved, dispersed, mixed, or otherwise disposed in the aqueous composition may be present as an anion, a cation, a salt, a neutral species, or a combination thereof.

In at least one implementation, the MIPs and/or the polymers thereof may be disposed in a vessel or container capable of or configured to contain or allow the aqueous composition to flow therethrough. For example, the MIPs and/or the polymers thereof may be disposed in a column (e.g., packed column), a filter, a frit, or the like, or any combination thereof. The vessel or container may include an inlet configured to receive the aqueous composition including the target substances (e.g., PFAS), a body fluidly coupled with the inlet and defining a volume or cavity configured to contain the MIPs and/or the polymers thereof, and an outlet fluidly coupled with the inlet via the volume or cavity and configured to dispense or expel the aqueous composition flowing through the vessel.

In at least one implementation, the method for removing PFAS from the aqueous composition may include disposing the MIPs or the polymers thereof in the vessel. The method may also include flowing the aqueous composition including the PFAS to and through the vessel from the inlet to the outlet. The method may also include contacting the aqueous composition with the MIPs, and/or the polymers thereof, disposed in the volume of the vessel. The method may further include adsorbing at least a portion of the PFAS with the MIPs and/or the polymers thereof to thereby remove at least a portion of the PFAS from the aqueous composition to thereby purify the aqueous composition into a purified aqueous composition. As used herein, the term or expression “purified aqueous composition” refers to an aqueous composition having at least a portion of the target substances removed therefrom.

In at least one implementation, the materials, MIPs, or polymers thereof may be capable of or configured to remove greater than or equal to about 80 mol-% of the target substances from the aqueous composition. For example, the purified aqueous composition may include at least 80 mol-% less of the target substances. In another example, the materials, MIPs, or polymers thereof may be capable of or configured to remove the target substances in an amount greater than or equal to about 80 mol-%, greater than or equal to about 82 mol-%, greater than or equal to about 84 mol-%, greater than or equal to about 86 mol-%, greater than or equal to about 88 mol-%, greater than or equal to about 90 mol-%, greater than or equal to about 92 mol-%, greater than or equal to about 94 mol-%, greater than or equal to about 96 mol-%, greater than or equal to about 98 mol-%, greater than or equal to about 99 mol-%, greater than or equal to about 99.5 mol-%, greater than or equal to about 99.9 mol-%, greater than or equal to about 99.99 mol-%, or more. In at least one implementation, about 1 gram (g) to about 10 g of the materials, MIPs, or polymers thereof may be capable of or configured to remove greater than or equal to 70%, greater than or equal to 75%, greater than or equal to 80%, greater than or equal to 85%, greater than or equal to 90%, greater than or equal to 92%, greater than or equal to 94%, greater than or equal to 96%, greater than or equal to 98%, greater than or equal to 99%, greater than or equal to 99.9%, or about 100% of the target substances from about 100 mL to about 1 L of the aqueous composition. For example, about 1 g of the materials, MIPs, or polymers thereof may be capable of or configured to remove greater than or equal to about 80% to about 100% of the target substance (e.g., PFAS) from about 100 ml of the aqueous composition.

In at least one implementation, the purified aqueous composition may include about 10 mol-% or less of the target substances (e.g., PFAS) as compared to the untreated or unpurified aqueous composition. In at least one implementation, the purified aqueous composition may include about 5 mol-% or less, about 1 mol-% or less, about 0.1 mol-% or less, or about 0.01 mol-% or less, of the PFAS as compared to the untreated or unpurified aqueous composition.

As discussed above, articles of manufacture that may include or utilize the MIPs or the polymers thereof are disclosed. The articles of manufacture may be or include any device or article Illustrative articles of manufacture may be or include, but are not limited to, a filter, a column, a frit, a fluidized bed, or the like. Suitable articles of manufacture may be employed at a water treatment facility, a home filtration system, a portable water filtration system, and the like. It should be appreciated that the materials, the MIPs, and/or the polymers thereof may be utilized for replacing conventional solid phase extraction (SPE) materials used in columns or tubes as retention elements for samples actively drawn through the columns.

It should be appreciated that the materials, the MIPs, and/or the polymers thereof may be utilized for sensors capable of or configured to report the presence of the target substances; for example, via a color change (either by a polymer incorporated chromophore, or an externally added reagent). For example, the MIPs or powders thereof may be prepared as a film that may be utilized or operably coupled with a capacitor to monitor dielectric changes due to the presence/absence of the target substances (e.g., PFAS). In at least one implementation, films containing a polyelectrolyte, such as poly (amino acid), may be incorporated into a “chemiresistor” that is capable of or configured to monitor the presence of the analyte via conductivity changes.

It should further be appreciated that the materials, the MIPs, and/or the polymers thereof may be monitored for one or more physical properties, such as transmittance (e.g., visible light transmittance), to determine the presence of the target substances. For example, the MIPs or powders thereof may be prepared as a transparent or semi-transparent film or other structure (e.g., particle). The transparent or semi-transparent MIPs or polymers may then be monitored for turbidity and/or refractive index to determine or monitor the presence of the target substances.

The following numbered paragraphs are directed to one or more exemplary variations of the subject matter of the application:
1. A crosslinked molecularly imprinted polymer (MIP), comprising a crosslinked polymer molecularly imprinted to have specific affinity for binding with a target substance, the target substance comprising one or more perfluoroalkyl or polyfluoroalkyl substances (PFAS), and the crosslinked polymer being molecularly imprinted with the target substance or an analog thereof.
2. The crosslinked molecularly imprinted polymer of paragraph 1, wherein the crosslinked polymer is one or more of a crosslinked polydiacetylene, a crosslinked polyvinylpyrrolidone, a crosslinked vinyl pyrrolidone-based polymer, a crosslinked poly(hydroxyethylmethacrylate), a crosslinked polyvinylidene chloride, a crosslinked polyaniline, a crosslinked poly(4-vinylphenol), a crosslinked polyurethane, a crosslinked nylon, a crosslinked polyvinylpyrrolidinone, a crosslinked polyethyleneimine, a crosslinked polystyrene, a crosslinked polymethylmethacrylate, or any combination thereof.
3. The crosslinked molecularly imprinted polymer of paragraph 1 or 2, wherein the crosslinked polymer defines a cavity configured to comprise specific affinity for binding with the target substance.
4. The crosslinked molecularly imprinted polymer of any one of paragraphs 1 to 3, wherein the cavity is configured to bind with the target substance via non-covalent bonding.
5. The crosslinked molecularly imprinted polymer of any one of paragraphs 1 to 4, wherein the crosslinked polymer is prepared by polymerizing monomers in the presence of a crosslinker.
6. The crosslinked molecularly imprinted polymer of any one of paragraphs 1 to 5, wherein the molar ratio of the crosslinker to the monomers is from about 1.5:1 to about 6:1.
7. The crosslinked molecularly imprinted polymer of any one of paragraphs 1 to 6, wherein the MIP is in the form of particles comprising an average particle size of from about 100 nm to about 5 μm.
8. The crosslinked molecularly imprinted polymer of any one of paragraphs 1 to 7, wherein the MIP is in the form of particles comprising an average particle size of from about 100 nm to about 500 nm.
9. The crosslinked molecularly imprinted polymer of any one of paragraphs 1 to 8, wherein the crosslinked polymer is molecularly imprinted with one or more of perfluorooctanoic acid, perfluorooctanesulfonic acid, or a combination thereof.
10. The crosslinked molecularly imprinted polymer of any one of paragraphs 1 to 9, wherein the one or more PFAS comprises one or more of Ethyl perfluorobutyl ether, Perfluorooctanesulfonic acid, Octafluoroadipamide, 2-Amino-2H-perfluoropropane, 1H,1H,5H-Perfluoropentanol, 3-(Perfluoro-2-butyl)propane-1,2-diol, Perfluoro(4-methoxybutanoic acid), Perfluoropentanamide, 11:1 Fluorotelomer alcohol, 2-(Perfluorooctyl)ethanol, Methyl perfluorobutanoate, Flurothyl, 4H-Perfluorobutanoic acid, Potassium perfluorobutanesulfonate, 4:4 Fluorotelomer alcohol, 3,3-Bis(trifluoromethyl)-2-propenoic acid, Perfluoropropyl trifluorovinyl ether, Perfluorobutanesulfonic acid, 3H-Perfluoro-4-hydroxy-3-penten-2-one, Heptafluorobutyramide, Perfluorobutanesulfonyl fluoride, 1H,1H-Perfluoropentylamine, 2-(Perfluorobutyl)-1-ethanesulfonic acid, N-Ethyl-N-(2-hydroxyethyl)perfluorooctane sulfonamide, 6H-Perfluorohex-1-ene, 1-Pentafluoroethylethanol, 1,1,1,3,3-Pentafluorobutane, Difluoromethyl 1H,1H-perfluoropropyl ether, Perfluorooctanoic acid, 2H,2H,3H,3H-Perfluorooctanoic acid, 3H-Perfluoro-2,2,4,4-tetrahydroxypentane, Perfluoro-3,6,9-trioxatridecanoic acid, 2-Aminohexafluoropropan-2-ol, 2-Vinylperfluorobutane, N-[(Perfluorooctylsulfonamido) propyl]-N,N,N-trimethylammonium iodide, Perfluoro-3,6-dioxaoctane-1,8-dioic acid, 3-(Perfluoropropyl)propanol, Perfluorohexanoic acid, Perfluoroisobutyl methyl ether, Pentafluoropropanoic anhydride, Methyl 2H,2H,3H,3H-perfluoroheptanoate, tris(Trifluoroethoxy)methane, 2,2-Difluoroethyl triflate, Perfluoroglutaryl difluoride, Hexafluoroamylene glycol, 3:1 Fluorotelomer alcohol, Nonafluoropentanamide, N-Methylperfluorooctanesulfonamide, 2-(Trifluoromethoxy)ethyl trifluoromethanesulfonate, Potassium perfluorooctanesulfonate, Ammonium perfluorooctanoate, 1-Propenylperfluoropropane, Potassium perfluorohexanesulfonate, Bis(1H,1H-perfluoropropyl)amine, 3,3,4,4,5,5,6,6,6-Nonafluorohexene, 5H-Perfluoropentanal, Perfluoro-3,6-dioxaheptanoic acid, Sevoflurane, 1H,1H,8H,8H-Perfluoro-3,6-dioxaoctane-1,8-diol, N-Ethylperfluorooctanesulfonamide, Perfluorononanoic acid, Perfluorobutyraldehyde, Methyl perfluoroethyl ketone, Perfluorooctanesulfonamide, 3-(Perfluoroisopropyl)-2-propenoic acid, 4:2 Fluorotelomer alcohol, Methyl perfluorohexanoate, Allyl perfluoroisopropyl ether, 2-(Perfluorohexyl)ethanol, 2-(Perfluorohexyl)ethyl methacrylate, 5H-Octafluoropentanoyl fluoride, Perfluorobutanoic acid, 1H,1H,7H-Dodecafluoro-1-heptanol, Perfluoro-2-methyl-3-oxahexanoic acid, or any combination thereof.
11. The crosslinked molecularly imprinted polymer of any one of paragraphs 1 to 10, wherein about 1 g of the crosslinked molecularly imprinted polymer is configured to remove greater than or equal to 80% of the target substance from about 100 mL of an aqueous composition.
12. The crosslinked molecularly imprinted polymer of paragraph 11, wherein the aqueous composition is groundwater, wastewater, tap water, a beverage, or a combination thereof.
13. A filter, comprising a vessel and the crosslinked molecularly imprinted polymer of any one of paragraphs 1 to 12 disposed in the vessel.
14. The filter of paragraph 13, wherein the vessel comprises: a body defining a volume disposed therein, wherein the molecularly imprinted polymer is disposed in the volume; an inlet fluidly coupled with the volume of the body; and an outlet fluidly coupled with the inlet via the volume of the body.
15. A method, comprising: contacting the crosslinked molecularly imprinted polymer of any one of paragraphs 1 to 12 with an aqueous composition comprising the target substance; and adsorbing a least a portion of the target substance of the aqueous composition with the crosslinked molecularly imprinted polymer.
16. The method of paragraph 15, wherein the crosslinked molecularly imprinted polymer defines a cavity configured to comprise specific affinity for binding with the target substance, and wherein adsorbing at least a portion of the target substance comprises adsorbing the target substance into the cavity of the crosslinked molecularly imprinted polymer.
17. The method of paragraph 15, further comprising desorbing at least a portion of the target substance from the crosslinked molecularly imprinted polymer.
18. The method of paragraph 17, wherein desorbing at least a portion of the target substance from the crosslinked molecularly imprinted polymer comprises washing the crosslinked molecularly imprinted polymer with a solvent.
19. A method for preparing a crosslinked molecularly imprinted polymer (MIP), the method comprising: imprinting a polymer with a target substance, an analog of the target substance, or a combination thereof such that the polymer has a specific affinity for binding with the target substance; and crosslinking the polymer, wherein the target substance comprises one or more perfluoroalkyl or polyfluoroalkyl substances (PFAS).
20. The method of paragraph 19, wherein the polymer comprises one or more of a polydiacetylene, a polyvinylpyrrolidone, a vinyl pyrrolidone-based polymer, a poly(hydroxyethylmethacrylate), a polyvinylidene chloride, a polyaniline, a poly(4-vinylphenol), a polyurethane, a nylon, a polyvinylpyrrolidinone, a polyethyleneimine, a polystyrene, a polymethylmethacrylate, or any combination thereof.

### EXAMPLES

Exemplary molecularly imprinted polymers (MIPs) were prepared according the present disclosure and evaluated for their respective efficacy for separating or removing PFAS target molecules from an aqueous composition. Particularly, MIPs were prepared with PFAS homologs as the template to imprint the polymers according to the present disclosure. The MIPs were evaluated for their efficacy for removing PFAS from an aqueous composition, namely, water containing a concentration of about 3,200 parts per trillion (ppt) or 3,200 ng/L of PFAS. To evaluate the efficacy, varying concentrations (i.e., 25 mg, 50 mg, and 100 mg) of the exemplary MIPs were contacted with the water containing about 3,200 ppt of PFAS for a time sufficient to allow adsorption of the PFAS with the MIPs. The resulting filtrate was evaluated for the presence and concentration of PFAS via gas chromatography-mass spectrometry (GC-MS). The MIPs were evaluated with a control containing an aqueous solution and no PFAS. The results are summarized in Table 1.

TABLE 1
Concentration of PFAS in Filtrate

| | | (1) | (2) | (3) |
|---|---|---|---|---|
| | | 25 mg | 50 mg | 100 mg |
| Sample | (Control) | of MIP | of MIP | of MIP |
| Concentration of PFAS | 10 ± 23 | 473 ± 58 | 282 ± 22 | 187 ± 38 |
| (ng/L) | | | | |
| % Efficacy | — | 85% | 91% | 94% |

As illustrated in Table 1, increasing amount of the MIPs resulted in a corresponding decrease in the amount of PFAS detected in the filtrate, which indicated that the MIPs were effective for removing the PFAS from the aqueous compositions. Notably, about 100 mg of the MIP was able to remove about 94% of the PFAS from the aqueous composition.

While the devices, systems, and methods have been described in detail herein in accordance with certain preferred implementations thereof, many modifications and changes therein may be affected by those skilled in the art. Accordingly, the foregoing description should not be construed to be limited thereby but should be construed to include such aforementioned obvious variations and be limited only by the spirit and scope of the following claims.

What is claimed is:

1. A crosslinked molecularly imprinted polymer (MIP), comprising a crosslinked polymer molecularly imprinted to have specific affinity for binding with a target substance, the target substance comprising one or more perfluoroalkyl or polyfluoroalkyl substances (PFAS), and the crosslinked polymer being molecularly imprinted with the target substance, an analog of the target substance, or a combination thereof.

2. The crosslinked molecularly imprinted polymer of claim 1, wherein the crosslinked polymer is one or more of a crosslinked polydiacetylene, a crosslinked polyvinylpyrrolidone, a crosslinked vinyl pyrrolidone-based polymer, a crosslinked poly(hydroxyethylmethacrylate), a crosslinked polyvinylidene chloride, a crosslinked polyaniline, a crosslinked poly(4-vinylphenol), a crosslinked polyurethane, a crosslinked nylon, a crosslinked polyvinylpyrrolidinone, a crosslinked polyethyleneimine, a crosslinked polystyrene, a crosslinked polymethylmethacrylate, or any combination thereof.

3. The crosslinked molecularly imprinted polymer of claim 1, wherein the crosslinked polymer defines a cavity configured to comprise specific affinity for binding with the target substance.

4. The crosslinked molecularly imprinted polymer of claim 3, wherein the cavity is configured to bind with the target substance via non-covalent bonding.

5. The crosslinked molecularly imprinted polymer of claim 1, wherein the crosslinked polymer is prepared by polymerizing monomers in the presence of a crosslinker.

6. The crosslinked molecularly imprinted polymer of claim 5, wherein the molar ratio of the crosslinker to the monomers is from about 1.5:1 to about 6:1.

7. The crosslinked molecularly imprinted polymer of claim 1, wherein the MIP is in the form of particles comprising an average particle size of from about 100 nm to about 5 μm.

8. The crosslinked molecularly imprinted polymer of claim 1, wherein the MIP is in the form of particles comprising an average particle size of from about 100 nm to about 500 nm.

9. The crosslinked molecularly imprinted polymer of claim 1, wherein the crosslinked polymer is molecularly imprinted with one or more of perfluorooctanoic acid, perfluorooctanesulfonic acid, or a combination thereof.

10. The crosslinked molecularly imprinted polymer of claim 1, wherein the one or more PFAS comprises one or more of Ethyl perfluorobutyl ether, Perfluorooctanesulfonic acid, Octafluoroadipamide, 2-Amino-2H-perfluoropropane, 1H,1H,5H-Perfluoropentanol, 3-(Perfluoro-2-butyl)propane-1,2-diol, Perfluoro(4-methoxybutanoic acid), Perfluoropentanamide, 11:1 Fluorotelomer alcohol, 2-(Perfluorooctyl)ethanol, Methyl perfluorobutanoate, Flurothyl, 4H-Perfluorobutanoic acid, Potassium perfluorobutanesulfonate, 4:4 Fluorotelomer alcohol, 3,3-Bis(trifluoromethyl)-2-propenoic acid, Perfluoropropyl trifluorovinyl ether, Perfluorobutanesulfonic acid, 3H-Perfluoro-4-hydroxy-3-penten-2-one, Heptafluorobutyramide, Perfluorobutanesulfonyl fluoride, 1H,1H-Perfluoropentylamine, 2-(Perfluorobutyl)-1-ethanesulfonic acid, N-Ethyl-N-(2-hydroxyethyl)perfluorooctane sulfonamide, 6H-Perfluorohex-1-ene, 1-Pentafluoroethylethanol, 1,1,1,3,3-Pentafluorobutane, Difluoromethyl 1H,1H-perfluoropropyl ether, Perfluorooctanoic acid, 2H,2H,3H,3H-Perfluorooctanoic acid, 3H-Perfluoro-2,2,4,4-tetrahydroxypentane, Perfluoro-3,6,9-trioxatridecanoic acid, 2-Aminohexafluoropropan-2-ol, 2-Vinylperfluorobutane, N-[(Perfluorooctylsulfonamido)propyl]-N,N,N-trimethylammonium iodide, Perfluoro-3,6-dioxaoctane-1,8-dioic acid, 3-(Perfluoropropyl)propanol, Perfluorohexanoic acid, Perfluoroisobutyl methyl ether, Pentafluoropropanoic anhydride, Methyl 2H,2H,3H,3H-perfluoroheptanoate, tris(Trifluoroethoxy)methane, 2,2-Difluoroethyl triflate, Perfluoroglutaryl difluoride, Hexafluoroamylene glycol, 3:1 Fluorotelomer alcohol, Nonafluoropentanamide, N-Methylperfluorooctanesulfonamide, 2-(Trifluoromethoxy)ethyl trifluoromethanesulfonate, Potassium perfluorooctanesulfonate, Ammonium perfluorooctanoate, 1-Propenylperfluoropropane, Potassium perfluorohexanesulfonate, Bis(1H,1H-perfluoropropyl)amine, 3,3,4,4,5,5,6,6,6-Nonafluorohexene, 5H-Perfluoropentanal, Perfluoro-3,6-dioxaheptanoic acid, Sevoflurane, 1H,1H,8H,8H-Perfluoro-3,6-dioxaoctane-1,8-diol, N-Ethylperfluorooctanesulfonamide, Perfluorononanoic acid, Perfluorobutyraldehyde, Methyl perfluoroethyl ketone, Perfluorooctanesulfonamide, 3-(Perfluoroisopropyl)-2-propenoic acid, 4:2 Fluorotelomer alcohol, Methyl perfluorohexanoate, Allyl perfluoroisopropyl ether, 2-(Perfluorohexyl)ethanol, 2-(Perfluorohexyl)ethyl methacrylate, 5H-Octafluoropentanoyl fluoride, Perfluorobutanoic acid, 1H,1H,7H-Dodecafluoro-1-heptanol, Perfluoro-2-methyl-3-oxahexanoic acid, or any combination thereof.

11. The crosslinked molecularly imprinted polymer of claim 1, wherein about 1 g of the crosslinked molecularly imprinted polymer is configured to remove greater than or equal to 80% of the target substance from about 100 ml of an aqueous composition.

12. The crosslinked molecularly imprinted polymer of claim 11, wherein the aqueous composition is groundwater, wastewater, tap water, a beverage, or a combination thereof.

13. A filter, comprising a vessel and the crosslinked molecularly imprinted polymer of claim 1.

14. The filter of claim 13, wherein the vessel comprises:
a body defining a volume disposed therein, wherein the molecularly imprinted polymer is disposed in the volume;
an inlet fluidly coupled with the volume of the body; and
an outlet fluidly coupled with the inlet via the volume of the body.

15. A method, comprising:
contacting the crosslinked molecularly imprinted polymer of claim 1 with an aqueous composition comprising the target substance; and
adsorbing a least a portion of the target substance of the aqueous composition with the crosslinked molecularly imprinted polymer.

16. The method of claim 15, wherein the crosslinked molecularly imprinted polymer defines a cavity configured to comprise specific affinity for binding with the target substance, and wherein adsorbing at least a portion of the target substance comprises adsorbing the target substance into the cavity of the crosslinked molecularly imprinted polymer.

17. The method of claim 15, further comprising desorbing at least a portion of the target substance from the crosslinked molecularly imprinted polymer.

18. The method of claim 17, wherein desorbing at least a portion of the target substance from the crosslinked molecularly imprinted polymer comprises washing the crosslinked molecularly imprinted polymer with a solvent.

19. A method for preparing a crosslinked molecularly imprinted polymer (MIP), the method comprising:
imprinting a polymer with a target substance, an analog of the target substance, or a combination thereof such that the polymer has a specific affinity for binding with the target substance; and
crosslinking the polymer, wherein the target substance comprises one or more perfluoroalkyl or polyfluoroalkyl substances (PFAS).

20. The method of claim 19, wherein the polymer comprises one or more of a polydiacetylene, a polyvinylpyrrolidone, a vinyl pyrrolidone-based polymer, a poly(hydroxyethylmethacrylate), a polyvinylidene chloride, a polyaniline, a poly(4-vinylphenol), a polyurethane, a nylon, a polyvinylpyrrolidinone, a polyethyleneimine, a polystyrene, a polymethylmethacrylate, or any combination thereof.
